(19) United States
(12) Patent Application Publication
(10) Pub. No.: US 2014/0098899 A1
(43) Pub. Date: Apr. 10, 2014

(54) SYSTEMS AND PROCESSES FOR ESTIMATING AND DETERMINING CAUSES OF VIDEO ARTIFACTS AND VIDEO SOURCE DELIVERY ISSUES IN A PACKET-BASED VIDEO BROADCAST SYSTEM

(71) Applicant: Cheetah Technologies, L.P., Pittsburgh, PA (US)

(72) Inventor: Praveen A. Mohandas, Thousand Oaks, CA (US)

(73) Assignee: CHEETAH TECHNOLOGIES, L.P., Pittsburgh, PA (US)

(21) Appl. No.: 14/046,623

(22) Filed: Oct. 4, 2013

Related U.S. Application Data
(60) Provisional application No. 61/710,368, filed on Oct. 5, 2012.

(51) Int. Cl. H04N 7/26

(52) U.S. Cl. CPC H04N 19/00909
USPC 375/240.27

(57) ABSTRACT

Estimating and determining causes of video artifacts and video source delivery issues is conducted by a hybrid approach utilizing both video coding layer with DCT information as well as pixel domain information. Coded syntax elements and data as well as sample information in the compressed frequency domain of the video coding layer is analyzed in real time and parallel image analysis algorithms are performed on pixel samples on the GPU core. Computed values from the video coding layer and the image layer are combined to deduce cause of the video artifact and video source delivery issues.

### BACKGROUND OF THE INVENTION

The present invention generally relates to systems and methods of estimating and determining causes of video artifacts and video source delivery issues in a packetized video stream. More particularly, the present invention relates to detecting video artifacts and causes of video artifacts and video source delivery issues in a packet-based video broadcast system, using coding layer with GPU-assisted image analysis.

In a typical broadcast systems, such as in IPTV (Internet Protocol Television) and direct broadcast satellite (DBS) applications, multiple video programs are encoded in parallel, and the digitally compressed bit streams are multiplexed onto a single, constant or variable bit rate channel. The video coding layer, such as MPEG2/H.264-AVC, is typically packetized into small fixed-size packets, such as MPEG2 Transport Stream, before transmission to an IP (Internet Protocol) network.

When video is transmitted over a packet-switched network, the coded sequence of video can suffer impairments from packet losses. Several other factors influence the overall picture quality as well. Picture distortion can be caused by quantization process in compression as well as quality degradation due to packet loss and error, propagation and temporal effects of the human visual system.

Video artifacts are introduced by the system due to packet loss that can cause loss of slices and macroblocks at the coding layer, network jitter that causes frame freezes or jerkiness, as well as blockiness and blur due to AC (non-zero frequencies) coefficients loss in the coded stream due to compression. These distortions can manifest as visual artifacts in the form of blockiness, blur, freeze, black screen or jerkiness.

Estimating the extent of packet loss and its error propagation to finally determine a quality score requires analyzing the effects of these distortions. Estimating distortions in pixel domain requires video to be uncompressed and applying frequency domain transformation (FFT) to separate high and low frequency components and perform analysis.

However, this process is computationally prohibitive as the number of channels that needs to be analyzed grows. Computation cost to run image analysis based artifact detection algorithms on a CPU can also be prohibitive.

Accordingly, there is a continuing need for a system and process for estimating and determining causes of video artifacts and video source delivery issues in a packet-based video broadcast system. The system and process should not be computationally or cost prohibitive. Further, a system and process is needed which determines physical network level elements which cause the video service degradation. The present invention fulfills these needs, and provides other related advantages.

### SUMMARY OF THE INVENTION

The present invention resides in a system and process for estimating and determining causes of video artifacts and video source delivery issues in a packet-based video broadcast system. The present invention is a hybrid approach, utilizing both video coding layer with DCT (Discrete Cosine Domain) information as well as pixel domain information, to detect artifacts and determine the root cause of the anomaly.

More particularly, the present invention provides a way to estimate video artifacts using a hybrid approach—information from the video coding layer in real time by the analysis of coded syntax elements and their data, as well as sample information in compressed frequency domain, as well as performing parallel image analysis algorithms on pixel samples. It is desirable to create parallel algorithms that can run on GPU (Graphics Processing Unit) cores, thereby offloading the main CPU (Central Processing Unit).

The process of the present invention generally comprises the steps of analyzing video coding layer information of a compressed video stream. Values of degradation of a video coding layer are computed. An image algorithm is run in a GPU that compute values of video artifacts at an image layer. The computed values from the video coding layer and the image layer are combined to deduce the cause of the video artifact and video source delivery issues.

Sample values of spatial predicted pixel values are extracted and sent to the GPU for image analysis. Typically, parallel image algorithms are run in the GPU. Parallel GUP threads may be run to compute image blockiness. Parallel GPU threads may also be run to compute image blur.

Discrete sections and information of the compressed video stream are analyzed. The discreet sections and information may comprise quantizer, slices, macroblocks, DC coefficients and AC coefficients. Loss blockiness is determined by analyzing and counting macroblock and slice losses. Blackout is determined by analyzing DC values. Video freeze is determined by analyzing DC values. Compression blockiness is determined by analyzing quantizer computations.

The physical network level elements which cause the video service degradation are determined. It may be determined that an encoder peak bandwidth setting needs to be increased when it is determined that a compression blockiness is high, a source blockiness is high, and a mean opinion score of the video is low and degraded. It may also be determined that an encoder peak bandwidth setting needs to be increased when it is determined that a compression blockiness is high, a loss blockiness is normal, a source blockiness is normal, and a mean opinion score of the video is low and degraded.

Alternatively, it may be determined that an upstream encoder rate setting and/or an upstream content provider need to be inspected when it is determined that a compression blockiness is normal, a source blockiness is high, and a mean opinion score of the video is low and degraded. It may also be determined that an upstream encoder rate setting and/or an upstream content provider need to be inspected when it is determined that blurriness is high, a compression blockiness is normal, a loss blockiness is normal, a source blockiness is normal, and a mean opinion score of the video is low and degraded.

It may be determined that a router queue or schedule and/or streaming encoder buffers need to be inspected when it is determined that freeze delivery is high, video freeze is high, blurriness is normal, a compression blockiness is normal, a loss blockiness is normal, a source blockiness is normal, and a mean opinion score of the video is low and degraded. It may also be determined that a router queue and/or streaming encoder buffers need to be inspected when it is determined that a loss blockiness is high, a source blockiness is normal, and a mean opinion score of the video is low and degraded.

The present invention can be used to provide a distributed system to estimate perceived video quality. The invention can be used to determine cost of IP packet loss, macroblock and slice losses. The present invention can be used to quickly determine video artifacts such as black screen, freeze, ghosting, jerkiness, blur and blocking.

The present invention can help a video service provider to determine the cause of video service degradation due to video content impairments, network jitter, losses, compression issues or service availability. The invention can also be used to perform root cause analysis to determine the cause of the video artifact in a service provider network.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 shows an example of an IPTV (IP Television) distribution network with potential measurement points;

FIG. 2 shows IP (Internet Protocol) packet to slices loss relationship;

FIG. 3 shows a typical protocol stack or layers where video coding layer content is encapsulated;

FIG. 4 shows the CPU (Central Processing Unit) and GPU (Graphical Processing Unit) tasks decomposition of video artifact detection algorithms;

FIG. 5 shows the original sample values of an 8×8 block;

FIG. 6 shows DC (non sinusoidal) and AC (sinusoidal) coefficients of an 8×8 block;

FIG. 7 shows how a modulation error in a cable network can cause freeze, blackout or blocky artifacts in video service layer;

FIG. 8 shows a decision tree used to determine the root cause of a video artifact;

FIG. 9 is a flow chart depicting steps for detecting freeze indications, in accordance with the present invention;

FIG. 10 is a flow chart depicting the steps in accordance with the present invention for detecting jerkiness indications;

FIG. 11 is a flow chart relating to partial compression blockiness computation, in accordance with the present invention;

FIG. 12 is a flow chart depicting the steps for partial loss blockiness computation, in accordance with the present invention;

FIG. 13 is a flow chart depicting the steps used in accordance with the present invention to compute blockiness using pixel values in image; and

FIG. 14 is a flow chart depicting the steps taken in accordance with the present invention for computing blur and image blockiness.

### DETAILED DESCRIPTION OF THE PREFERRED EMBODIMENTS

The present invention, as shown in the accompanying drawings for purposes of illustration, relates to a system and process for estimating and determining causes of video artifacts and video source delivery issues in a packet-based video broadcast system. As will be more fully described herein, the present invention analyzes the video coding layer information of a compressed video stream and computes values of degradation of the video coding layer, and also computes values of video artifacts at an image layer, preferably utilizing the GPU, and combines the computed values to deduce the cause of the video artifact and video source delivery issues. The present invention can also be used to determine physical network level elements which are causing the video service degradation.

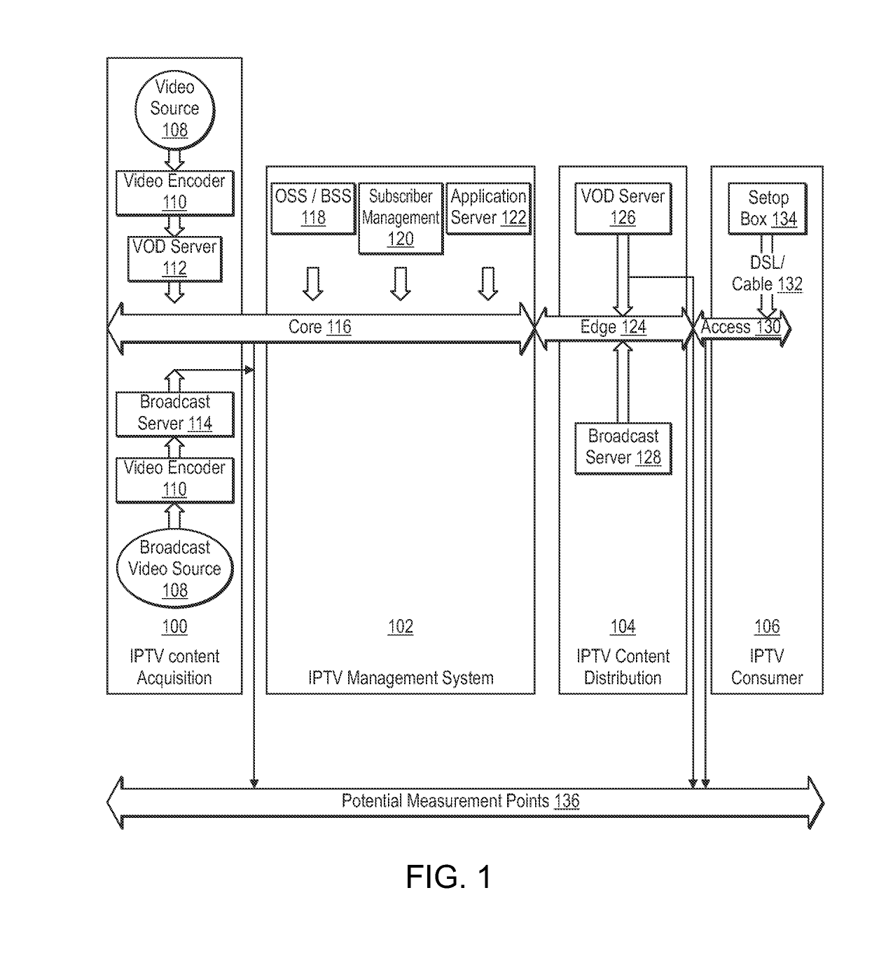

The present invention can be used in an IPTV (Internet Protocol Television) delivery system. FIG. 1 shows the network system components that are involved in delivering video content in a typical IPTV environment. Video source that originates as analog signal is encoded using an encoder and packetized and sent using an IP network. It could be sent as multicast or unicast destination to the network. The core contains various elements to provision and manage subscribers and traffic flows. The content could also be stored in content servers and delivered on demand by the user. At various points in the network, measurements can be performed for impairments by service assurance management systems.

As outlined above, FIG. 1 shows a typical IPTV distribution network which includes IPTV content acquisition 100, IPTV management system 102, IPTV content distribution 104 and IPTV consumer 108 segments. Video source 108 is usually acquired in analog form and encoded, either in MPEG 1/2/4 format, by a video encoder 110 and sent to a Video on Demand (VOD) server 112 or a broadcast server 114. VOD 112 encapsulates the content into a program stream for transport to a network core 116. The network core 116 is a relatively higher bandwidth pipe.

An IPTV network will also consist of a variety of management, provisioning and service assurance elements. Typically it could include an Operation Support System (OSS) and/or Broadcast Support System (BSS) 118, subscriber management system 120 and application servers 122 to create new value added services.

At the edge 124 of the server, the content could be stored in a VOD server 126 or a broadcast server 128 that is located close to the consumer 106. It is typically located at an edge 124 of the network. A consumer has access to their broadband access line 130, which could be a Cable/DSL line 132. A television is typically connected to a setop box 134 that decodes the video stream to component output.

It will be appreciated by those skilled in the art that there are many places along the network where errors, artifacts and the like can be introduced or delivery issues experienced with the video packet and stream. These errors can occur during encoding, packetization, compression, etc. The implementation of new hardware or software or the communication links within the network can also contribute to the video source delivery issues and video artifacts. FIG. 1 illustrates potential measuring points 136 where these errors can be estimated or detected.

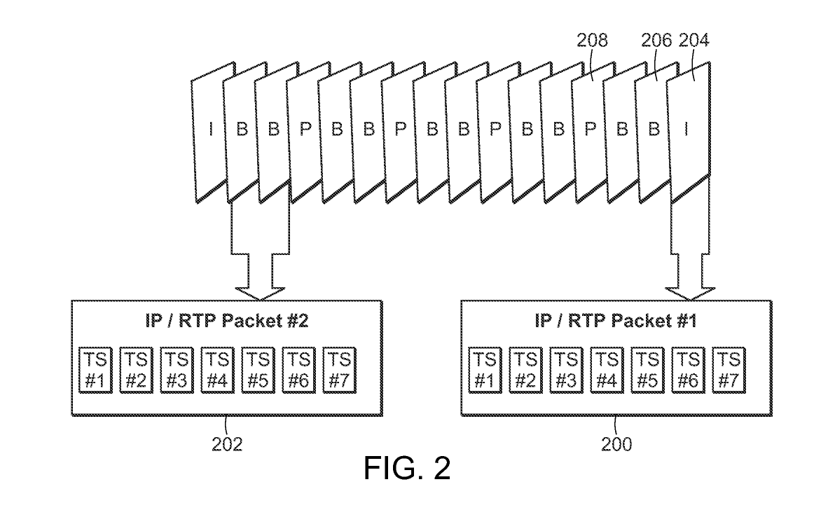

FIG. 2 shows how video is transported in an IP network utilizing real-time transport protocol (IP/RTP). Each IP packet contains multiple video transport stream (MPEG2TS) packets, labeled TS #1-#7 in FIG. 2. Typically, there are six video packets and one audio packet in a single IP packet. Each transport stream packet can also contain packets related to video coding layer information. For purposes of illustration, only two video transport stream packets 200 and 202 are illustrated. Video coding layer (compression layer) packets can contain a sequence of I-frame (same frame prediction) 204, B-frame (Bi predictive) 206 and P-Frame (predicted frame) 208. I-frame can contain only video blocks that are predicted using the same frame. B-frame can contain blocks predicted from either a previous or a subsequent I/P frame. P-frame can contain only blocks predicted from previous I/B frames. As illustrated in FIG. 2, when an IP packet is lost, much of the prediction information from the video coding layer can also be lost, creating visible artifact.

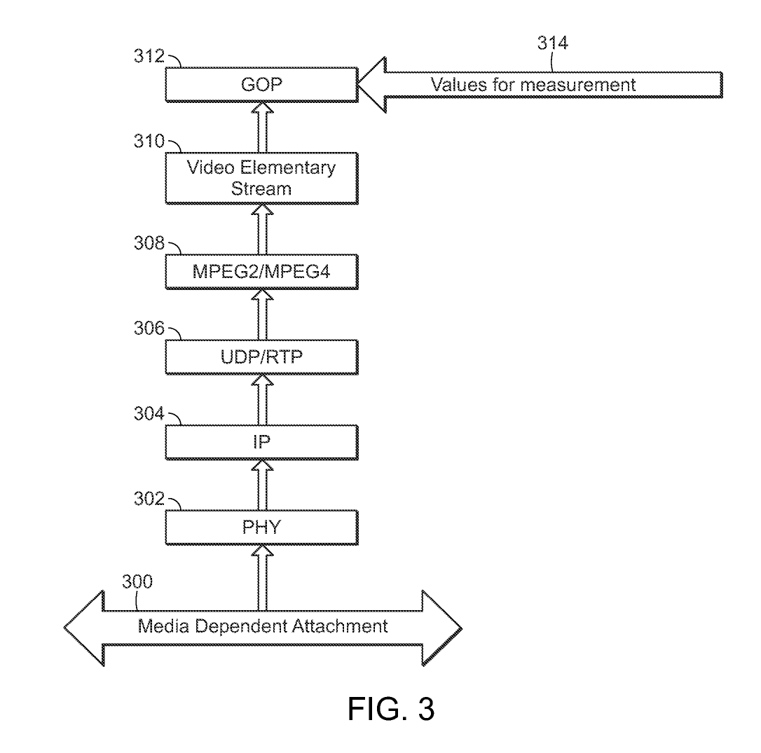

A protocol stack for a packetized video stream is illustrated in FIG. 3. Media dependent attachment 300 could be Ethernet, Sonet, DS3, cable, or DSL interface. The media dependent packet processing occurs at the physical (PHY) layer 302. The physical layer is responsible for converting bits of information into data packets that are transferred on the network. The IP network layer 304 provides mainly addressing for packet routing in the IPTV network. A transport layer, such as User Datagram Protocol/Real-Time Transport Protocol (UDP/RTP) 306 provides application level addressing for ports. The video stream could be encapsulated in the UDP/RTP or just UDP layer. The encoded video could be compressed 308, such as in either MPEG1/2/4, and sent as a transport stream. A video elementary stream 310 is decoded and a group of pictures (GOP) 312 are extracted to finally get the values for measurement 314 for the artifact detection methods.

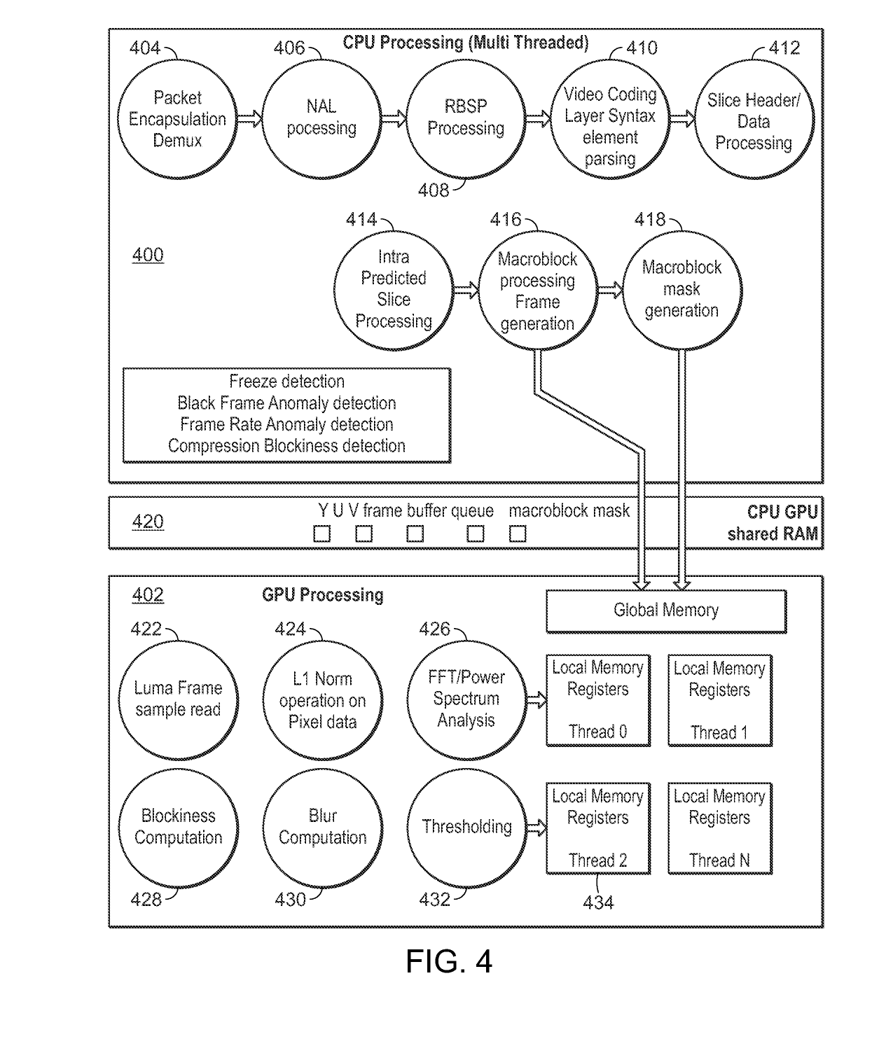

FIG. 4 shows the various hybrid tasks that are distributed across the CPU 400 and GPU 402. Video coding layer parsing is defined by the standards, and they involve packet de-multiplexing 404, network adaptation layer (NAL) processing 406, Raw Byte Sequence Packet (RBSP) processing 408, video coding layer syntax element parsing 410, and slice header and data processing 412. Each video frame is typically divided into 16×16, 8×8, 8×4 or 4×4 blocks of pixel values. These blocks are called macroblocks. During the compression process, these pixel values go through a prediction process 414, meaning the values that are same are predicted within the same frame (Intra predicted) or from a different frame (Inter predicted). After the macroblock values are decoded for the intra predicted frames 416, the sizes of the macroblock are passed in the macroblock mask generation process 418.

The pixel values and their block structure are passed through the CPU/GPU shared Random Access Memory (RAM) 420 and onto the GPU 402 for further processing and computation. At the CPU/GPU shared RAM 420, the pixel value is passed through a YUV frame buffer queue and macroblock mask. Pixel values have Y (luminance) and Cb and Cr (color) components. These values and macroblock mask are sent to the shared memory between CPU and GPU for computation.

The GPU process of the image has functions like the luma frame sample read 422, the L1 norm operation on pixel data 424, which measures the absolute distance between the pixels and FFT (Fast Fourier Transform) to convert from sample domain to frequency domain 426. Blockiness computation block 428 computes the level of blockiness in the image, likewise Bluriness computation block 430 computes blurriness in the image. After the computations, thresholding is performed 432, to allow certain values that meet or exceed a certain value to be considered in final computation. Each operation can be assigned to a GPU local memory register thread 434 that will allow the computations to execute in parallel.

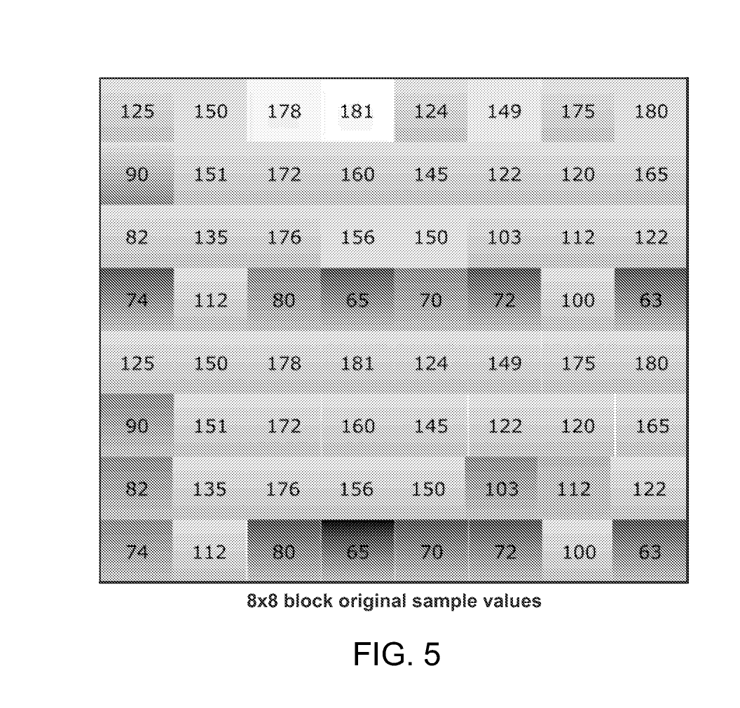

FIG. 5 shows the video frame sample values at the pixel level for each 8×8 block within the frame. Each frame is typically compressed as an 8×8 block. After the decoding process, these sample values are used to compute blockiness and blurriness.

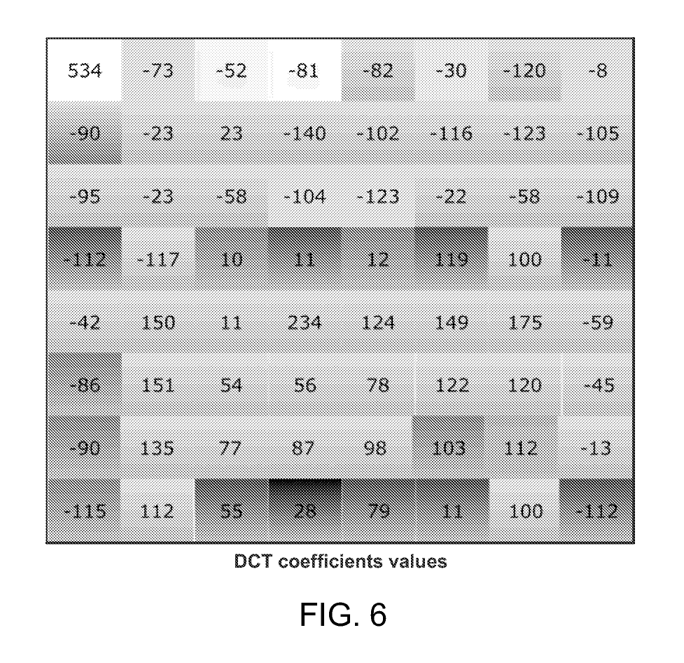

FIG. 6 shows the values in compressed domain. The last step in the compression process is to convert the sample to the frequency domain. In the frequency domain, there is DC component located at [0,0] of the 8×8 block (macroblock) structure, which is the upper left corner block of FIG. 6, which represents the average of the sample values of FIG. 5. The rest of the values or blocks in FIG. 6 are called AC (sinusoidal) coefficients derived by performing FFT (Fast Fourier Transform). Coding layer uses a type of FFT called DCT (Discrete Cosine Transform) operating on 8×8 array of 64 sample values, and produces 8×8 array of transform coefficients. The values in the [0,0] entry—DC coefficient, are the average of the original pixel intensity values illustrated in FIG. 5. All the other coefficients in FIG. 6 are referred to as AC.

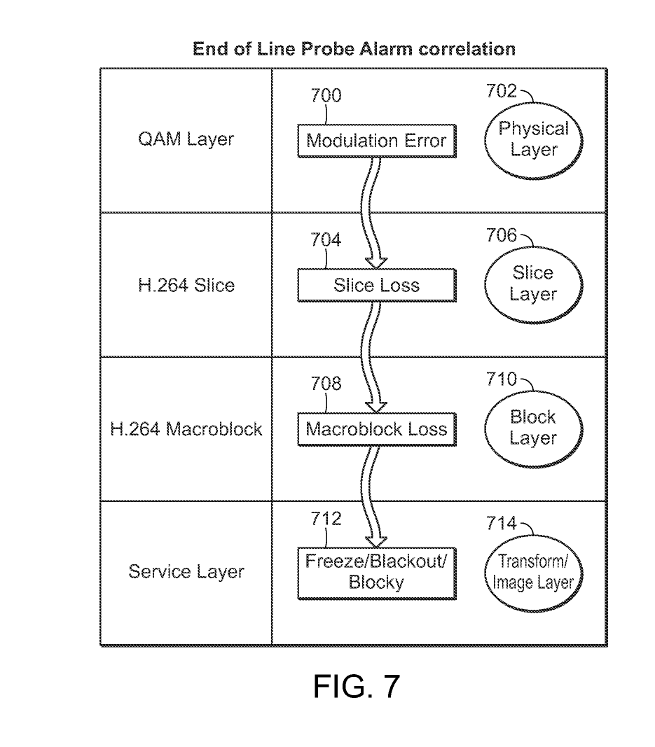

FIG. 7 illustrates how a modulation error 700 in the physical layer or line 702 causes a slice loss 704 at the slice layer 706 and a macroblock loss 708 at the block layer 710. This can manifest itself into visual artifacts such as freeze, blackout or blocky images 712 at the transform/image layer 714. In a cable network, QAM (quadrature amplitude modulation) layer represents the physical modulation system, H.264 Slice and H.264 Macroblock are the video compression layers, before the video stream is sent to the service layer.

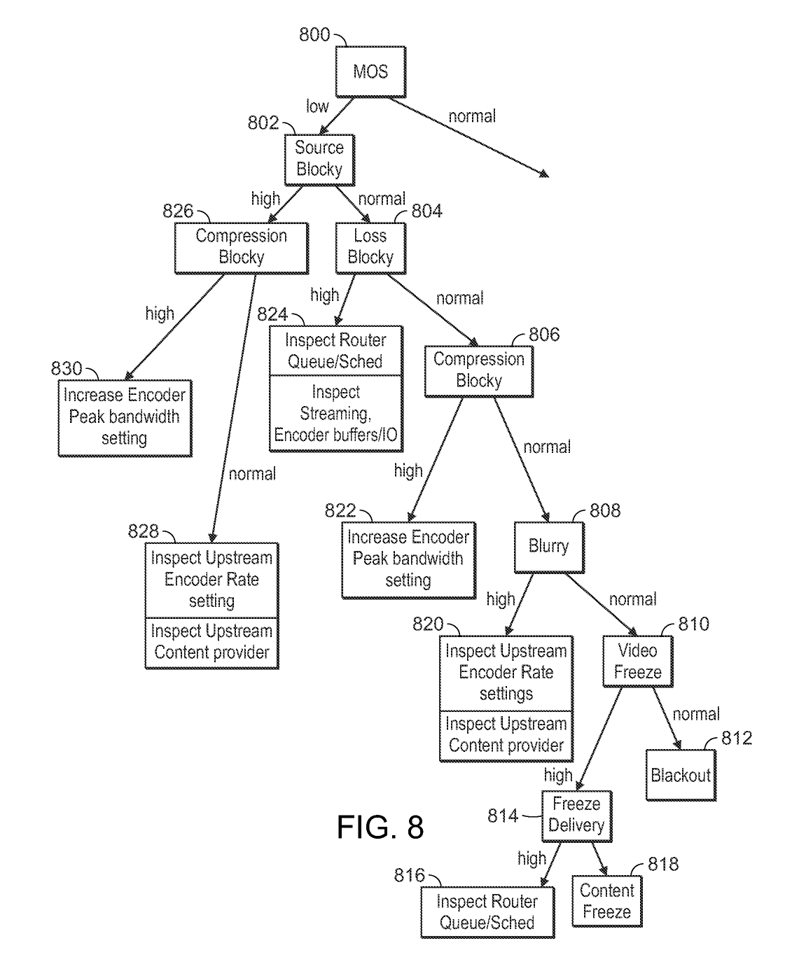

FIG. 7 shows the error propagation in various packet and video layers that will create a visual artifact. Root cause analysis can be performed to determine the root cause of artifact using a decision tree illustrated in FIG. 8. Mean Opinion Score (MOS) of video ranges from 1-5. If the MOS is degraded to a low value, such as below 3, then the cause can be determined by traversing this decision tree, as will be more fully described herein.

From FIG. 6, the procedure to detect blackout is as follows: After decoding the video to the transform values in the macroblock, DC values at each INTRA predicted (containing only spatial prediction) macroblock are read. All DC values in the frame are examined for black levels. When all the values in a frame indicate black level, this indicates start of a blackout. From then on, all subsequent frames are checked for the black levels. Frame count for the black frames is incremented for each frame. This operation is repeated till a non-black level frame is received.

Detailed pseudocode for detecting blackout can be implemented as follows:

| | |
|---|---|
| 1) | In video encoding frames can have a mixture of intra (prediction of |
| | the macroblock is within the same frame) or inter predicted |
| | (prediction of sample values can happen from a different frame) |
| | macroblocks. First step is to read Intra predicted macroblocks |
| | from Intra predicted frame from the coded stream. |
| 2) | Initialize blackstate variable to false, blackstartframe to current frame |
| | number and blackoutevents to zero. |
| 3) | Initialize blackstarttime variable to time of day. |
| 4) | For each macroblock in the frame |

| | |
|---|---|
| a. | Read DC component at block[0,0] in each macroblock location. |
| b. | If (block[0,0] equals 128). |

| | |
|---|---|
| i. | If (blackstate equals false) set blackstarttime to current |
| | time, blackstate to true. |

Else if (blackstate equals true AND blackstartframe not

| | |
|---|---|
| | equals current frame number). |
| ii. | Set blackoutduration to elapsed time from |
| | Blackstarttime. |
| iii. | Increment blackoutevents. |
| iv. | Set blackstate to false. |

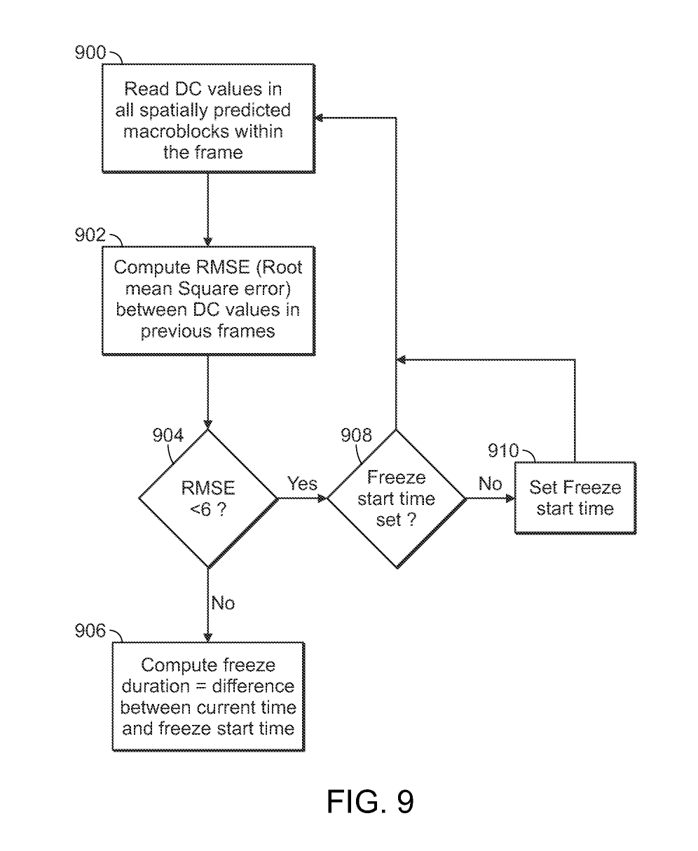

With reference now to FIG. 9, a flowchart is shown illustrating steps taken in detecting freeze, in accordance with the present invention. The DC values in all spatially predicted macroblocks within the frame are read 900. The Root Mean Square Error (RMSE) between DC values in previous frames is computed 902. It is then determined whether the computed RMSE is less than six 904. If not, the freeze duration is computed, which equals the difference between the current time and the freeze start time 906. However, if the RMSE is less than six, it is then determined whether the freeze start time has been set 908. If not, the freeze start time is set 910, and the DC values are read again.

After decoding the video to the transform values in the macroblock, DC values at each INTRA predicted macroblock are read. All DC values from all the blocks in the frame are stored in memory. These values are compared with DC values from all subsequent frames using RMSE. Frames that show similarity are counted as frozen frames.

Detailed pseudocode for the procedure to detect freeze can be implemented as follows:

| | |
|---|---|
| 1) | Read Intra predicted macroblocks from Intra predicted frame from the |
| | coded stream. |
| 2) | Initialize prev_dc_values[ ] array and current_dc_values[ ] array, |
| | variable freezeduration to zero, and freezestate to false. |
| 3) | For each macroblock in the frame: |

| | |
|---|---|
| a. | Read DC value at block[0,0]; |
| b. | Store DC value of previous frame in prev_dc_values[ ]; |
| c. | Store DC values of current frame in current_dc_value[ ]. |

| | |
|---|---|
| 4) | Compute RMSE (Root Mean Square Error) of DC values by: |

| | |
|---|---|
| a. | Value = Current_dc_values[ ] − previous_dc_values[ ], |
| b. | Square Value, |
| c. | RMSE = SquareRoot(Square Value/samples), |
| d. | If (RMSE < 6) same_picture = true. |

| | |
|---|---|
| 5) | if (same_picture ): |

| | |
|---|---|
| a. | freezestate = true; |
| b. | Set freezestarttime to current time. |

Else if (freezestate equals true):

| | |
|---|---|
| a. | Freezeduration = current time − freeze, |
| b. | Increment freeze_events, |
| c. | freezestate = false. |

To detect jerkiness, the actual frame rate at which the frame needs to be rendered is read from the compressed bitstream. Received frame arrival time is noted. Deviation from the original frame rate is computed and the value obtained is treated as jerkiness.

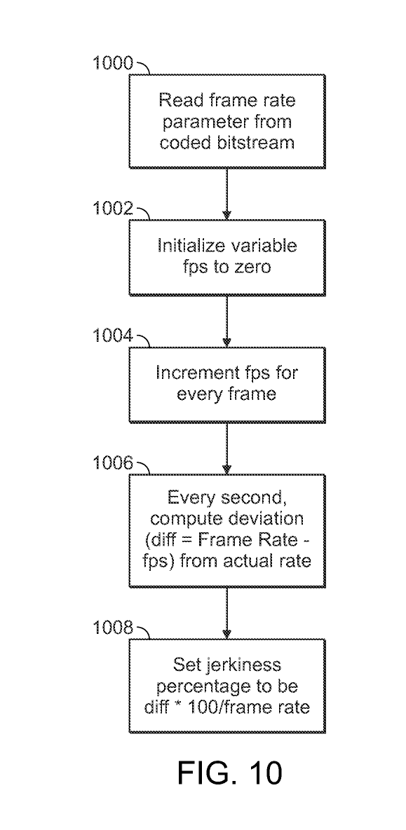

More particularly, with reference to FIG. 10, the frame rate parameter from the coded bitstream is read 1000. The variable FPS is initialized to zero 1002. The FPS (frames per second) is incremented for every frame 1004. Every second, the deviation (the difference being the frame rate minus the FPS) from the actual rate is computed 1006. The jerkiness percentage to be the difference times the one hundred/frame rate is set 1008.

Detailed pseudocode to detect jerkiness can be implemented as follows:

1) Compute frame rate from coded stream. In H.264 it can be computed by
Sequence Parameter Set.
2) Frame rate = Sequence Parameter Set Time Scale / units in tick * 2.
3) Increment variable fps for every frame indication.
4) Compute deviation from actual rate.
5) Set Diff variable to Frame Rate − fps.
6) Jerkiness percentage = diff * 100.0/framerate.

Block-based video compression involves block partitioning of the image prior to several other processing steps. The image being encoded is partitioned into 8×8 blocks, and DCT (Discrete Cosine Transform) applied to the pixels in each block. The lowest frequency component (DC) maps to the index 0 transform coefficient, while the highest frequency component maps to index 7 transform coefficient, which is the order of human visual systems sensitivity. Each DCT coefficient in each block is independently quantized prior to an entropy coding procedure. At low bit rates blocking artifacts appear at the block boundaries due to the loss of AC (high frequency) coefficients in quantization process. Reason for the blocking artifacts is due to the independent quantization of each block. Blockiness is detected by analyzing the quantizer at the macroblock.

In MPEG2, the two dimensional array of coefficients is inverse quantized to produce the reconstructed DCT coefficients. This process is essentially a multiplication by the quantizer step size. The quantizer step size is modified by two mechanisms: 1) a weighting matrix is used to modify the step size within a block; and 2) a quantizer scale factor is used in order that the step size can be modified at the cost of only a few bits (as compared to encoding an entire new weighting matrix). The cumulative quantization in a picture is determined using quantizer matrix and quantizer scale factor in each of the macroblock. Average quantization per macroblock is computed. The model knows the level of quantization that constitutes 100% blockiness on an average block basis. The percentage of blockiness from this level is computed for each picture. Maximum blockiness gives the picture with highest blockiness level among a series of pictures as computed by the quantizer model.

In a compressed bitstream, quantization parameter specifies the level of compression i.e the amount of high frequency component (AC) value loss that cause blocky artifact. This parameter is compared against a predefined threshold derived from the deblocking filter values in compressed bitstream. If the quantization parameter exceeds the threshold value, it is treated as level of blockiness being high.

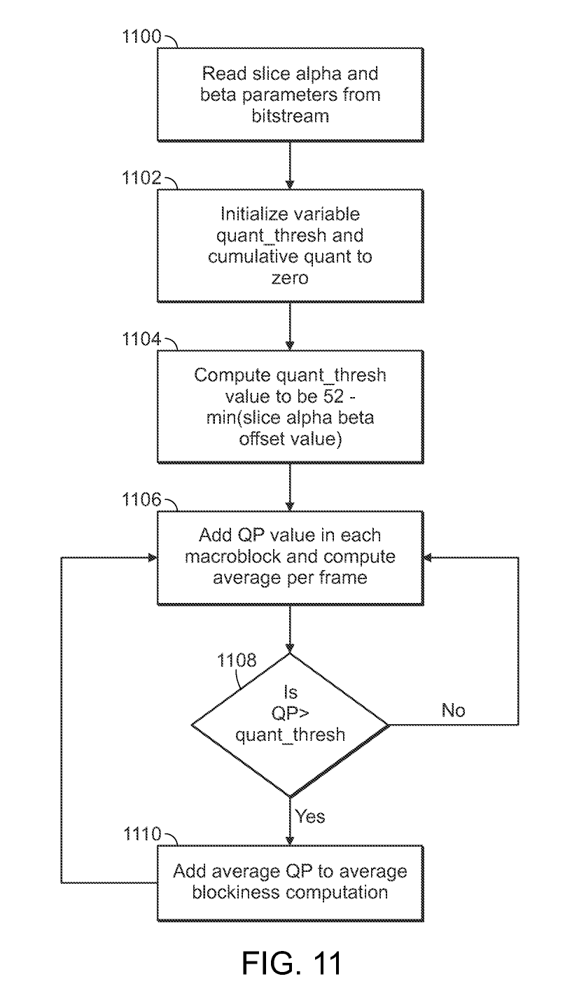

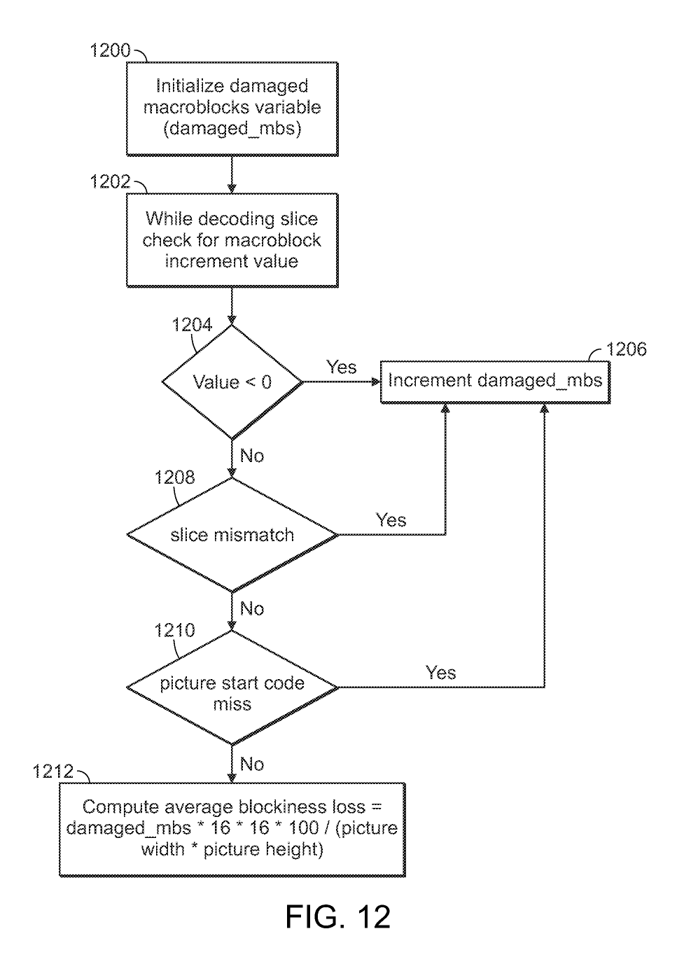

FIGS. 11 and 12 show steps taken in the procedure to compute blockiness at the compressed domain. The slice alpha and beta parameters are read from the bitstream 1100. Variable quant_thresh and cumulative quant are initialized to zero 1102. The quant_thresh value is computed to be 52-min slice alpha beta offset value 1104. The QP (quantization parameter) value in each macroblock is added and the average per frame is computed 1106. It is then determined whether the QP is greater than the quant_thresh 1108. If not, step 1106 is performed again. However, if so, the average QP is added to the average blockiness computation 1110.

With reference now to FIG. 12, the damaged macroblock's variable (damaged_MBS) is initialized 1200. While the coding slice, macroblock increment values are checked for 1202. If the value is determined to be less than zero 1204, then the increment is damaged_MBS 1206. However, if not, it is determined if there is a slice mismatch 1208. If so, the increment is damaged_MBS 1206. However, if not, it is determined if the picture start code is missed 1210. If so, increment damage_MBS 1206. If not, the average blockiness loss is computed which equals damaged_MBS times sixteen, times sixteen, times one hundred, divided by (picture width times picture height) 1212.

Pseudocode to compute AC coefficient loss and blockiness is as follows:

| | |
|---|---|
| 1) | Read slice alpha and beta offset parameters for deblocking filter from |
| | compressed stream. |
| 2) | Initialize quant_threshold and cumulative_quant variable to zero. |
| 3) | Set quant_threshold variable to 52 - minimum of slice alpha and beta |
| | offset parameters. |
| 4) | Compute average quant_threshold per macroblock for the INTRA |
| | coded picture. |
| 5) | For each INTRA coded macroblock increment num_quants. |
| 6) | For each QP value in the macroblock add and set |
| | cumulative_quant_variable. |
| 7) | Average blockiness = cumulative_quant / num_quants. |
| 8) | If (Average blockiness > quant_threshold) Set Average blockiness to |
| | Average blockiness / quant_threshold. |
| 9) | Average blockiness = Average blockiness * 1.2. |
| 10) | Compute blockiness due to loss as follows: |
| 11) | Initialize damaged_mbs and lost_frames to zero, |
| | pict_damaged_state to false. |
| 12) | If (CABAC (Context Adaptive Binary Arithmetic) bytestream ended |
| | abruptly) increment damaged_mbs. |
| 13) | During intra prediction 4×4 mode check if top block available, if |
| | not increment damaged_mbs. |
| 14) | During intra prediction 4×4 check if left block available, if not |
| | increment damaged_mbs. |
| 15) | Check and apply 13 & 14 for all intra prediction modes and inter |
| | prediction modes. |
| 16) | Set total_blocks to (picture height * picture width) / 16. |
| 17) | In memory management operation of reference picture list, if (long |
| | reference count + short reference count > Sequence parameter set |
| | reference frame count) increment lost_frames. |
| 18) | damaged_mbs = damaged_mbs + (total_blocks * lost_frames). |
| 19) | picture damaged percentage = (damaged_mbs * 100) / |
| | total_blocks. |
| 20) | if (current picture number is not equal to previous picture number): |

| | |
|---|---|
| a. | increment num_pict_damaged_percentage, |
| b. | if (picture damaged percentage > 40) increment picture damaged |
| | events. |

| | |
|---|---|
| 21) | Average blockiness due to losses = cumulative picture damaged |
| | percentage / num_pict_damaged_percentage. |
| 22) | For MPEG2 coding following procedure is followed. |
| 23) | Read scan table index and assign to j. |
| 24) | Initialize variable qscale from macroblock, q, cumulativequant, |
| | numquant to zero and quantization matrix to INTRA quantization |
| | matrix. |
| 25) | Set q to qscale * quant_matrix[j]. |
| 26) | Cumulative add and store cumulativequant to variable q. |
| 27) | Increment numquant. |
| 28) | Initialize quant_thresh variable to following: |

| | |
|---|---|
| a. | If (resolution of picture greater than or equal to 1920) set |
| | quant_thresh to 1300, |
| b. | If (resolution of picture greater than or equal to 720) set |
| | quant_thresh to 1400, |
| c. | If (resolution of picture greater than or equal to 480) set |
| | quant_thresh = 1500, |

| | |
|---|---|
| 29) | For current picture number not equal to previous picture number |

| | |
|---|---|
| a) | Set Average Compression Blockiness percentage = (cumulative |
| | quant * 100) / quant_thresh. |

| | |
|---|---|
| 30) | To compute blockiness due to macroblock damage follow |
| | this procedure: |

| | |
|---|---|
| a) | Initialize variable damaged_mbs to zero, |
| b) | In slice decoder check for macroblock increment value, if (value |
| | less than 0) increment damaged_mbs, |
| c) | check for slice mismatch by checking macroblock skip run |
| | value, if not equal to zero increment damaged_mbs, |
| d) | if (macroblock skip run and picture type == INTRA_TYPE) |
| | increment damaged_mbs, |
| e) | check for missing picture start code, if true increment |
| | damaged_mbs, |
| f) | For every I/B/P picture type macroblock read macroblock |
| | parameters, read mb type field, if invalid increment |
| | damaged_mb. |

| | |
|---|---|
| 31) | Compute final blockiness due to loss, |

| | |
|---|---|
| a) | Average loss blockiness = (damaged_mbs * 16 *16 * 100) / |
| | (picture width * picture height). |

Video decoding up to the transform values are performed according to the standard. Packet encapsulation de-multiplexing, VCL (Video Coding Layer) syntax element processing and macroblock processing are scheduled on CPU threads as illustrated in FIG. 4. The output of above computation generates INTRA (spatial) predicted frames along with the macroblock boundary masks (FIG. 4). This process generates YUV (luminance and color) component values. The GPU thread blocks read the YUV sample values to compute artifacts by applying image analysis. High Level pseudo code is given below.

Frame buffer is transferred to global shared CPU/GPU memory and assigned to a thread from thread block in GPU core.
1) While buffer queue between CPU and GPU is free, copy luma sample values and mask on to the shared memory queue between CPU and GPU as well as coding layer params—width (W), height (H), coding type.
   High level procedure is as follows:
1) Compute row wise vertical pixel differences, output is 2D difference matrix, assign this operation per GPU thread.
2) Compute row-wise L1-Norm of the difference matrix obtained from step-1, assign per GPU thread. Output is 1D column vector.
3) Perform FFT operation on L1-Norm samples to estimate block spectrum peaks, assign per GPU thread.
4) Spectrum peak is blocky, if its power>(surrounding power+threshold).
5) Repeat steps 1-4 for computing column-wise horizontal pixel differences.

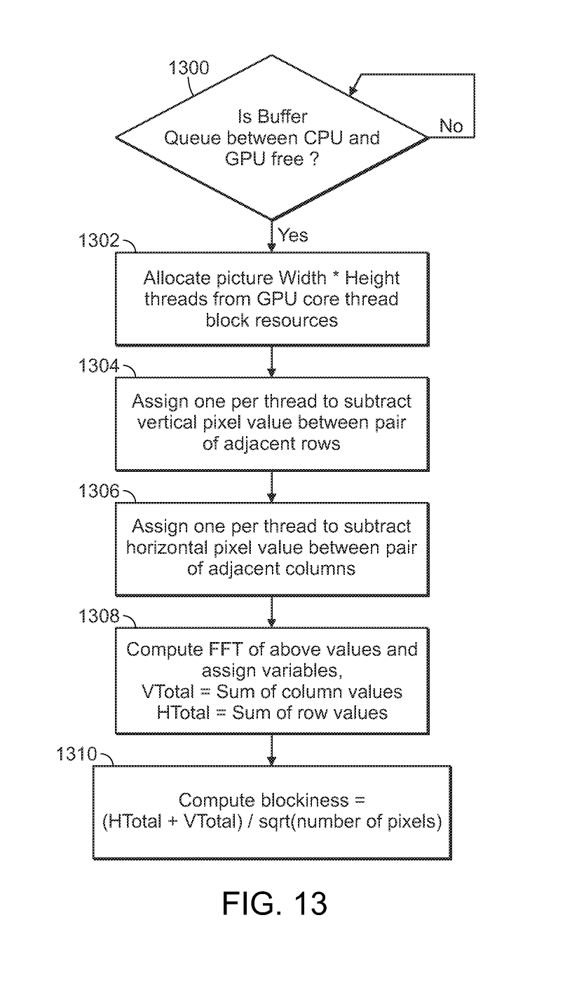

With reference now to FIG. 13, it is determined whether the buffer queue between the CPU and GPU is free 1300. If not, this process is repeated until the buffer queue is free. Picture width times height threads from the GPU core thread block resources are then allocated 1302. The system then assigns one per thread to subtract vertical pixel value between pair of adjacent rows 1304. It is then assigned one per thread to subtract horizontal pixel value between pair of adjacent columns 1306. The FFT is computed of above values and assigned variables, with vertical total (VTotal) equaling the sum of the column values, and the horizontal total (HTotal) equaling the sum of the row values 1308. Blockiness is then computed, which equals the HTotal+VTotal/sqrt (number of pixels) 1310, where sqrt is the square root of the number of pixels.

Detailed pseudocode to compute blockiness is as follows:

| 2) If (stream type == MPEG2) | |
|---|---|
| a. | Compute vertical blockiness using FFT (Fast Fourier |
| | Transform) based power spectrum, |
| b. | Allocate W * H-1 threads from the GPU core thread block |
| | resources, |
| c. | Perform vertical pixel wise subtraction between pair of |
| | adjacent rows, assigning operation to a thread, |
| d. | Compute row-wise L1-Norm of the difference matrix |
| | obtained from c). Number of threads needed for the |
| | operation is H-1, |
| e. | Compute FFT on H-1 samples and the power spectrum, |
| f. | Blockiness_vertical = sum of power at all the blocky |
| | peaks, |
| g. | Repeat steps a-f for computing Blockiness_horizontal, |
| h. | Average_Source_Blockiness = |
| | (Blockiness_vertical+Blockiness_horizontal)/2. |

If (stream_type==H264) Compute Source_Blockiness using following high level pseudocode,

| | |
|---|---|
| 1) | Compute blockiness horizontal, Assign following block to GPU core |
| | thread block, |

| | |
|---|---|
| a. | For each row traverse pixel by pixel, if mask set for the pixel |
| | location, perform following, |
| b. | Store pixel value, ‘pValue’ if minGrad < pValue < MaxGrad |
| c. | Increment ‘count’, |
| d. | Maintain value ->Sum += pValue, |
| e. | Confirm as Blocky if: |

| | |
|---|---|
| i. | minBlockLen < count < maxBlockLen, |
| ii. | Sum > threshold, |
| iii. | Add (Sum−threshold) to RowTotal, |

| | |
|---|---|
| d. | Blockiness-Horizontal H-total = Sum(RowTotal), |
| e. | For V-Edges Repeat H-edge procedure replacing rows by |
| | columns, assign operation to GPU thread block allocating local |
| | GPU core memory, |
| f. | Blockiness-Vertical, V-Total = Sum(ColumnTotal), |
| g. | Source_Blockiness = (H-Total + V-Total)/sqrt(number of |
| | pixels) * 3. |

In order to compute blur, in accordance with the present invention, each row of images are read. The pixels are traversed from left to right. The current pixel difference is calculated and compared with previous, and assigned the operation on a per-GPU-thread basis. If there is a sudden opposite gradient, trait as a blurry edge based on a threshold value. Both positive and negative gradients are looked for. From the above, the total blurriness is estimated.

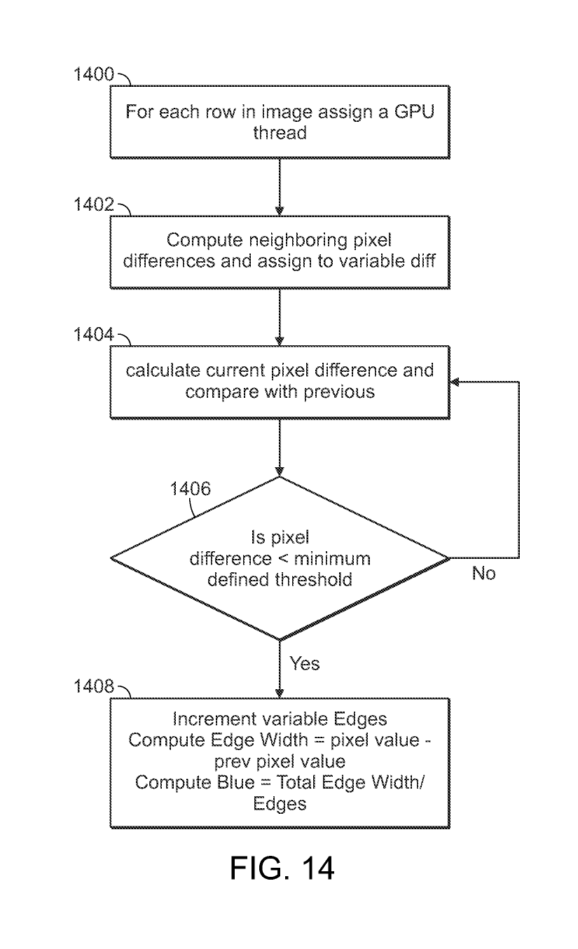

With reference to FIG. 14, each row in the image is assigned a GPU thread 1400. The neighboring pixel differences are computed and assigned to variable difference 1402. The current pixel difference is calculated and compared with previous 1404. It is then determined if the pixel difference is less than the minimum defined threshold 1406. If not, step 1404 is repeated. If so, the increment variable edges are computed, with the edge width equaling the pixel value minus the previous pixel value. The blue is also computed, which equals the total edge width divided by edges 1408.

Blur is computed using following parallel algorithm:

| | |
|---|---|
| 1) | for (i=0; I < height; i++), |
| 2) | Assign following operation in GPU thread, number of GPU threads |
| | required is H, |

| | |
|---|---|
| a. | diff = V(i+3) − V(i+2), Mark = V(i+2), |
| b. | first_diff = V(i+1) − V(i), |
| c. | Compute previous pixel difference, diff2 = V(i+2) − V(i+1), |
| d. | For Positive gradient (first_diff > 0), |
| e. | If (Diff2 >= 0), then first_diff += Diff2, |
| f. | Else if (Diff2 < −minDiffOpposite ) \|\| (Diff1+Diff2 <=0), then: |

| | |
|---|---|
| i. | Edges++; |
| ii. | EdgeWidth = x-Mark; |
| iii. | EdgePixels += EdgeWidth; |
| iv. | Blur = EdgePixels/Edges. |

With reference again to FIGS. 7 and 8, FIG. 7 shows the error propagation in various packet and video layers which can create a visual artifact. The root cause or physical network elements causing the video service degradation can be determined using the decision tree of FIG. 8. The following examples illustrate the expressions derived from the decision tree.
1) To determine the cause of video freeze, start from the root node 800 to check if MOS value is low (1-3).
   a. Traverse to the next node 802 to determine if the source blockiness computed by image analysis exceeded the threshold. Since this is freeze, the condition is normal and will fall to the node “loss blocky” 804.
   b. The condition is normal will fall to node “Compression blocky” 806.
   c. Since Compression blocky does not show high value, the condition will fall to node blurry 808 and then to node “Video Freeze” 810 as blurriness was determined to be normal.
   d. If the video freeze condition is determined to be normal, then there is a blackout 812.
   e. However, if the node Freeze Delivery 814 shows high values, the root cause is determined as follows:
      i. If freeze duration exceeds user set threshold, determine the cause—possible causes are losses or jitter.
      ii. If losses, determine the nature of losses—bursty or single at the IP layer as well as transport. Determine cost of loss by looking at the I slice and B or P slice losses as well as extent of macroblock damage.
      iii. If bursty losses, check the burstiness of packet arrival in IP burstiness duration, if the burstiness duration is not high, the cause of loss is not due to bursty packet transmission by the router scheduler, but due to loss induced by network elements in service provider network topology.
      iv. If no losses, check if freeze is caused by late picture arrival, if true, check the scheduling in the network to make sure SLA's are set properly for the service.
      v. If the freeze delivery 814 is high, the router queue and scheduling should be inspected 816. If not, it is determined that it is freeze related to content 818.

If freeze related to content as seen by RMSE (Root Mean Square Error) procedure described in above sections, check to see, if encoder SDI (Serial Digital Interface) sync loss caused the video frame repetition. If not, check to see if the video content has repeated frames embedded in it, by replaying alarmed event video snapshot.

If the blurriness 808 is high and exceeds the predetermined threshold, the upstream encoder rate settings and content provider are inspected 820.

If it is determined that the compression blockiness 806 is high and exceeds the predetermined threshold, the encoder peak bandwidth setting is increased 822.

If the loss blockiness 804 is determined to be high and exceeding the predetermined threshold, the router queue and network schedule may be inspected and/or the streaming encoder buffers/in-out (IO) may require inspection 824.

If the source blockiness 802 is determined to be high and exceeding the predetermined threshold, it is then determined whether the compression is blocky at node 826. If it is normal, the upstream encoder rate setting may be inspected and/or the upstream content provider may be inspected 828. However, if the compression blockiness is deemed to be high and exceeding predetermined thresholds, the encoder peak bandwidth setting may need to be increased 830.

Blockiness cause can be diagnosed using following method—source can be transcoding, prior source, compression or block damage:

```
a. If (Average_Source_Blockiness > pre_determined threshold),
        i. If (Compression_blockiness > pre_determined threshold)
          blockiness_source = COMPRESSION,
        Else if (blockiness_macroblock_loss > pre_determined
        threshold) blockiness_source = BLOCK_DAMAGE or
        PACKET_LOSS,
        Else if (blur > pre_determined threshold)
          Blockiness_source = TRANSCODE or SOURCE,
        Else blockiness_source = TRANSCODE.
b. If (Average_Source_Blockiness > pre_determined threshold),
        i. If (Compression_blockiness > pre_determined threshold)
        blockiness_source = COMPRESSION,
        ii. Else if (blockiness_macroblock_loss > pre_determined
        threshold) blockiness_source = BLOCK_DAMAGE or
        PACKET_LOSS.
```

Although several embodiments have been described in detail for purposes of illustration, various modifications may be made without departing from the scope and spirit of the invention. Accordingly, the invention is not to be limited, except as by the appended claims.

What is claimed is:

1. A process for estimating and determining causes of video artifacts and video source delivery issues in a packet-based video broadcast system, comprising the steps of:
analyzing video coding layer information of a compressed video stream;
computing values of degradation of a video coding layer;
running an image algorithm in a GPU to compute values of video artifacts at an image layer; and
combining the computed values from the video coding layer and the image layer to deduce cause of the video artifact and video source delivery issues.

2. The process of claim 1, wherein the step of running an image algorithm comprises the step of running parallel image algorithms in the GPU.

3. The process of claim 1, including the steps of extracting sample values of spatial predicted pixel values, and sending the sample values to the GPU for image analysis.

4. The process of claim 3, including the step of running parallel GPU threads to compute image blockiness.

5. The process of claim 3, including the step of running parallel GPU threads to compute image blur.

6. The process of any of claims 1-3, including the step of analyzing discrete sections and information of the compressed video stream.

7. The process of claim 6, wherein the discrete sections and information comprise quantizer, slices, macroblocks, DC coefficients and AC coefficients.

8. The process of claim 7, including the step of determining loss blockiness by analyzing and counting macroblock and slice losses.

9. The process of claim 7, including the step of determining blackout by analyzing DC values.

10. The process of claim 7, including the step of determining video freeze by analyzing DC values.

11. The process of claim 7, including the step of determining compression blockiness by analyzing quantizer computations.

12. The process of any of claim 1-3 or 6, including the step of determining physical network level elements causing video service degradation.

13. The process of claim 12, including the step of determining that an encoder peak bandwidth setting needs to be increased when it is determined that a compression blockiness is high, a source blockiness is high, and a mean opinion score of the video is low and degraded.

14. The process of claim 12, including the step of determining that an upstream encoder rate setting and/or an upstream content provider need to be inspected when it is determined that a compression blockiness is normal, a source blockiness is high, and a mean opinion score of the video is low and degraded.

15. The process of claim 12, including the step of determining that an encoder peak bandwidth setting needs to be increased when it is determined that a compression blockiness is high, a loss blockiness is normal, a source blockiness is normal, and a mean opinion score of the video is low and degraded.

16. The process of claim 12, including the step of determining that an upstream encoder rate setting and/or an upstream content provider need to be inspected when it is determined that blurriness is high, a compression blockiness is normal, a loss blockiness is normal, a source blockiness is normal, and a mean opinion score of the video is low and degraded.

17. The process of claim 12, including the step of determining that a router queue or schedule and/or streaming encoder buffers need to be inspected when it is determined that freeze delivery is high, video freeze is high, blurriness is normal, a compression blockiness is normal, a loss blockiness is normal, a source blockiness is normal, and a mean opinion score of the video is low and degraded.

18. The process of claim 12, including the step of determining that a router queue or schedule and/or streaming encoder buffers need to be inspected when it is determined that a loss blockiness is high, a source blockiness is normal, and a mean opinion score of the video is low and degraded.
